(19) United States
(12) Patent Application Publication
(10) Pub. No.: US 2023/0097726 A1
(43) Pub. Date: Mar. 30, 2023

(54) METHOD AND DEVICE FOR SUPPORTING GENERATION OF DEDICATED PDU SESSION FOR PARTICULAR USER TRAFFIC

(71) Applicant: LG ELECTRONICS INC., Seoul (KR)

(72) Inventors: Sangmin PARK, Seoul (KR); Hyunsook KIM, Seoul (KR); Myungjune YOUN, Seoul (KR); Sunhee KIM, Seoul (KR)

(73) Assignee: LG ELECTRONICS INC., Seoul (KR)

(21) Appl. No.: 17/928,541

(22) PCT Filed: May 31, 2021
(86) PCT No.: PCT/KR2021/006712

§ 371 Date: Nov. 29, 2022

(30) Foreign Application Priority Data
May 29, 2020 (KR) 10-2020-0065253

(51) Int. Cl. H04W 76/10; H04W 28/02

(52) U.S. Cl. CPC H04W 76/10; H04W 28/0263; H04W 80/10

(57) ABSTRACT

Provided are a method and a device for supporting generation of a dedicated protocol data unit (PDU) session for particular user traffic. A user equipment (UE) operating in a wireless communication system determines whether to establish a dedicated protocol data unit (PDU) session exclusively used for traffic matched to a particular traffic descriptor (TD), on the basis that a route selection descriptor (RSD) associated with the particular TD includes an indicator indicating whether to establish the dedicated PDU session. The UE requests a network to establish the dedicated PDU session on the basis of the determination of dedicated PDU session establishment.

### TECHNICAL FIELD

The present disclosure relates to a method and apparatus for supporting generation of dedicated protocol data unit (PDU) sessions for particular user traffic.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In 5G NR, the UE may transmit user data by creating/establishing a protocol data unit (PDU) session for connection with a data network (DN). A PDU session may have various attributes. The attribute for classifying the PDU session may include a data network name (DNN), single network slice selection assistance information (S-NSSAI) indicating a network slice to which the PDU session belongs, etc.

### SUMMARY

Even user data traffic having the same characteristics may need to be delivered via a separate PDU session in some cases.

In an aspect, a method performed by a user equipment (UE) operating in a wireless communication system is provided. The method includes, based on a route selection descriptor (RSD) associated with a specific traffic descriptor (TD) including an indicator indicating whether to establish a dedicated protocol data unit (PDU) session dedicated to traffic matching the specific TD, determining whether to establish the dedicated PDU session, and based on determining to establish the dedicated PDU session, requesting, to the network, establishment of the dedicated PDU session.

In another aspect, an apparatus for implementing the above method is provided.

The present disclosure can have various advantageous effects.

For example, in a situation in which a PDU session is used according to the URSP in the 5G system, a separate and/or dedicated PDU session can be established/used for traffic having the same RSD.

For example, a PDU session can be separated for each traffic characteristic, and through this, user experience enhancement and security enhancement can be achieved.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows an example of UE to which implementations of the present disclosure is applied.

FIG. 5 shows an example of 5G system architecture to which implementations of the present disclosure is applied.

FIG. 6 shows an example of a method performed by a UE to which implementations of the present disclosure is applied.

FIG. 7 shows an example of an RSD according to the first implementation of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G new radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

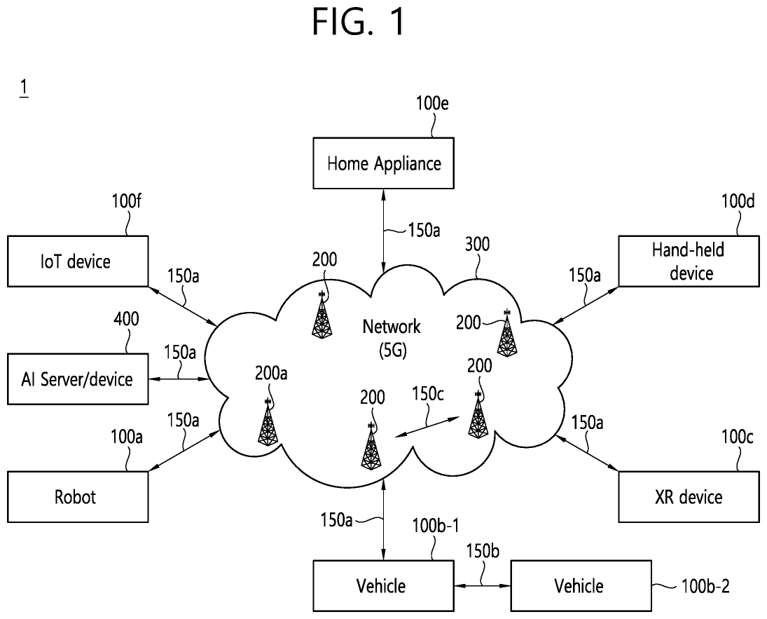

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

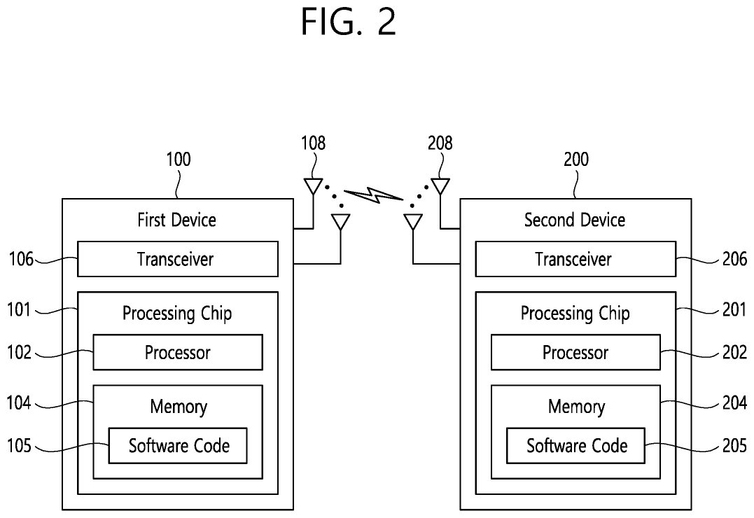

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be adapted to include the modules, procedures, or functions. Firmware or software adapted to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

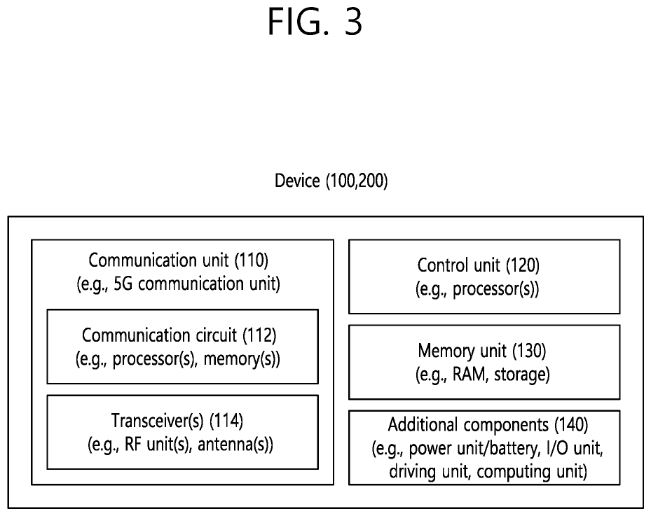

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

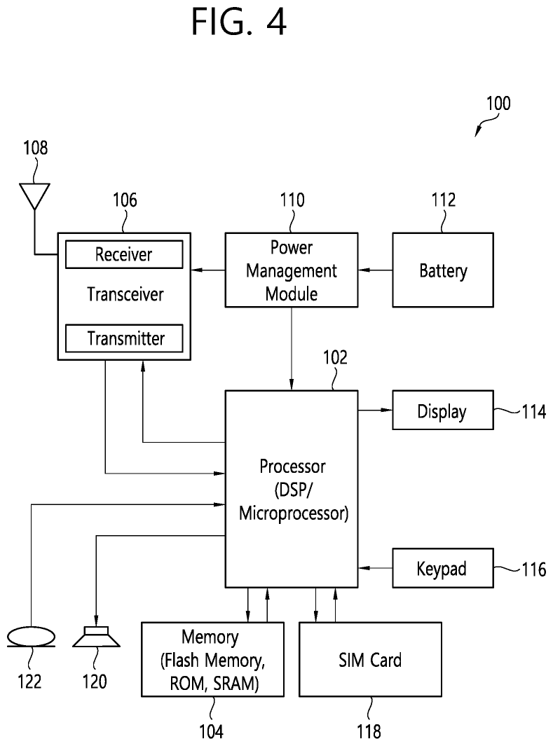

FIG. 4 shows an example of UE to which implementations of the present disclosure is applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 110, a battery 112, a display 114, a keypad 116, a subscriber identification module (SIM) card 118, a speaker 120, and a microphone 122.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 116 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

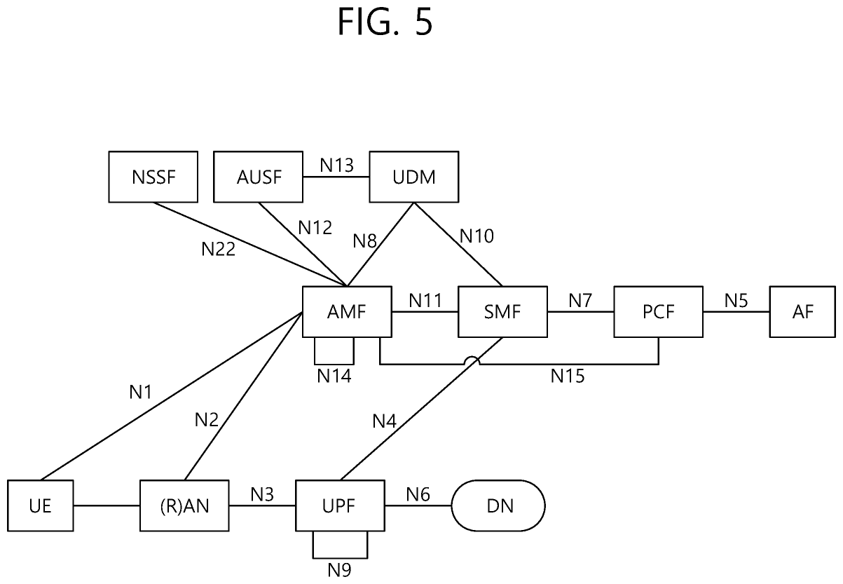

FIG. 5 shows an example of 5G system architecture to which implementations of the present disclosure is applied.

The 5G system (5GS) architecture consists of the following network functions (NF).
Authentication Server Function (AUSF)
Access and Mobility Management Function (AMF)
Data Network (DN), e.g., operator services, Internet access or 3rd party services
Unstructured Data Storage Function (UDSF)
Network Exposure Function (NEF)
Intermediate NEF (I-NEF)
Network Repository Function (NRF)
Network Slice Selection Function (NSSF)
Policy Control Function (PCF)
Session Management Function (SMF)
Unified Data Management (UDM)
Unified Data Repository (UDR)
User Plane Function (UPF)
UE radio Capability Management Function (UCMF)
Application Function (AF)
User Equipment (UE)
(Radio) Access Network ((R)AN)
5G-Equipment Identity Register (5G-EIR)
Network Data Analytics Function (NWDAF)
CHarging Function (CHF)

Furthermore, the following network functions may be considered.
Non-3GPP InterWorking Function (N3IWF)
Trusted Non-3GPP Gateway Function (TNGF)
Wireline Access Gateway Function (W-AGF)

FIG. 5 depicts the 5G system architecture in the non-roaming case, using the reference point representation showing how various network functions interact with each other.

In FIG. 5, for the sake of clarity of the point-to-point diagrams, the UDSF, NEF and NRF have not been depicted. However, all depicted Network Functions can interact with the UDSF, UDR, NEF and NRF as necessary.

For clarity, the UDR and its connections with other NFs, e.g., PCF, are not depicted in FIG. 5. For clarity, the NWDAF and its connections with other NFs, e.g., PCF, are not depicted in FIG. 5.

The 5G system architecture contains the following reference points:
N1: Reference point between the UE and the AMF.
N2: Reference point between the (R)AN and the AMF.
N3: Reference point between the (R)AN and the UPF.
N4: Reference point between the SMF and the UPF.
N6: Reference point between the UPF and a Data Network.
N9: Reference point between two UPFs.

The following reference points show the interactions that exist between the NF services in the NFs.
N5: Reference point between the PCF and an AF.
N7: Reference point between the SMF and the PCF.
N8: Reference point between the UDM and the AMF.
N10: Reference point between the UDM and the SMF.
N11: Reference point between the AMF and the SMF.
N12: Reference point between the AMF and the AUSF.
N13: Reference point between the UDM and the AUSF.
N14: Reference point between two AMFs.
N15: Reference point between the PCF and the AMF in the case of non-roaming scenario, PCF in the visited network and AMF in the case of roaming scenario.
N16: Reference point between two SMFs, (in roaming case between SMF in the visited network and the SMF in the home network).
N22: Reference point between the AMF and the NSSF.

In some cases, a couple of NFs may need to be associated with each other to serve a UE.

A UE route selection policy (URSP) will be described. Section 6.6.2 of 3GPP TS 23.503 V16.4.1 and section 4.2 of 3GPP TS 24.526 V16.3.0 may be referred.

When user data traffic is generated in the UE, it may be determined by the URSP of the UE through which PDU session to transmit. The URSP may include one or more URSP rules indicating a requested operation according to traffic. Each URSP rule may be composed of a rule precedence, a traffic descriptor (TD) corresponding to the rule criterion, and a route selection descriptor (RSD) corresponding to an operation according to each URSP rule.

(1) Rule Precedence

The rule precedence determines the order the URSP rule is enforced in the UE. That is, the rule precedence identifies the precedence of the URSP rule among all the existing URSP rules. Each URSP rule in a URSP have different precedence values.

(2) Traffic Descriptor

Each URSP rule contains a TD that determines when the rule is applicable. The TD includes one or more components which will be described below. A URSP rule is determined to be applicable when every component in the TD matches the corresponding information from the application. A URSP rule is determined not to be applicable when for any given component in the TD:
No corresponding information from the application is available; or
The corresponding information from the application does not match any of the values in the TD component.

If a URSP rule is provided that contains a TD with two or more components, it is recommended to also provide URSP rule(s) with lower precedence and a TD with less components, in order to increase the likelihood of URSP rule matching for a particular application.

The TD includes either:

1) match-all traffic descriptor; or

2) at least one of the following components:

A) one or more application identifiers;

B) one or more IP 3 tuples, i.e., the destination IP address, the destination port number, and the protocol in use above the IP;

C) one or more non-IP descriptors, i.e., destination information of non-IP traffic;

D) one or more DNNs;

E) one or more connection capabilities; and

F) one or more domain descriptors, i.e., destination fully qualified domain name (FQDN); and

(3) one or more RSDs

Each URSP rule contains a list of RSDs containing one or more RSDs. Each RSD has a different RSD precedence value. A RSD contains one or more of the following components.
Session and Service Continuity (SSC) Mode: Indicates that the traffic of the matching application should be routed via a PDU session supporting the included SSC mode.
Network Slice Selection: Indicates that the traffic of the matching application should be routed via a PDU session supporting any of the included S-NSSAIs. It includes one or more S-NSSAI(s).
DNN Selection: Indicates that the traffic of the matching application should be routed via a PDU session supporting any of the included DNNs. It includes one or more DNN(s). When DNN is used in TD, corresponding RSD of the rule does not include DNN selection component.
PDU Session Type Selection: Indicates that the traffic of matching application should be routed via a PDU session supporting the included PDU session type.
Non-Seamless Offload Indication: Indicates that traffic of the matching application is to be offloaded to non-3GPP access outside of a PDU session when the rule is applied. If this component is present in an RSD, no other components is included in the RSD.
Access Type Preference: If the UE needs to establish a PDU session when the rule is applied, this indicates the access type (3GPP or non-3GPP or multi-access) on which the PDU session should be established. The type “Multi-Access” indicates that the PDU session should be established as a MA PDU session, using both 3GPP access and non-3GPP access.
Time Window: The RSD is not be considered valid unless the UE is in the Time window.
Location Criteria: The RSD is not be considered valid unless the UE's location matches the Location Criteria.

Table 3 shows an example of RSD.

TABLE 3

| | | | PCF permitted | |
|---|---|---|---|---|
| Information | | | to modify in | |
| name | Description | Category | URSP | Scope |
| Route Selection | Determines the order in which | Mandatory | Yes | UE |
| Descriptor | the RSDs are to be applied. | | | context |
| Precedence | | | | |
| Route selection | | Mandatory | | |
| components | | | | |
| SSC Mode | One single value of SSC mode. | Optional | Yes | UE |
| Selection | | | | context |
| Network Slice | Either a single value or a list of | Optional | Yes | UE |
| Selection | values of S-NSSAI(s). | | | context |
| DNN Selection | Either a single value or a list of | Optional | Yes | UE |
| | values of DNN(s). | | | context |
| PDU Session | One single value of PDU | Optional | Yes | UE |
| Type Selection | Session Type | | | context |
| Non-Seamless | Indicates if the traffic of the | Optional | Yes | UE |
| Offload | matching application is to be | (NOTE 4) | | context |
| indication | offloaded to non-3GPP access | | | |
| | outside of a PDU Session. | | | |
| Access Type | Indicates the preferred Access | Optional | Yes | UE |
| preference | Type (3GPP or non-3GPP or | | | context |
| | Multi-Access) when the UE | | | |
| | establishes a PDU Session for | | | |
| | the matching application. | | | |
| Route Selection | | Optional | | |
| Validation | | | | |
| Criteria | | | | |
| Time Window | The time window when the | Optional | Yes | UE |
| | matching traffic is allowed/The | | | context |
| | RSD is not considered to be | | | |
| | valid if the current time is not in | | | |
| | the time window. | | | |
| Location | The UE location where the | Optional | Yes | UE |
| Criteria | matching traffic is allowed/The | | | context |
| | RSD rule is not considered to be | | | |
| | valid if the UE location does not | | | |
| | match the location criteria. | | | |

In the case of network rejection of the PDU session establishment request, the UE may trigger a new PDU session establishment based on the rejection cause and the URSP policy.

When the PCF provisions URSP rules to the UE, one URSP rule with a “match all” TD may be included.

The URSP rule with the “match all” TD is used to route the traffic of applications which do not match any other URSP rules, and therefore, may be evaluated as the last URSP rule, i.e., with lowest priority. There is only one RSD in this URSP rule. The RSD in this URSP rule includes at most one value for each route selection component.

Only one URSP rule in the URSP may be a default URSP rule and the default URSP rule contains a match all TD. If a default URSP rule and one or more non-default URSP rules are included in the URSP, any non-default URSP rule has have lower precedence value than (i.e., shall be prioritized over) the default URSP rule.

If a TD lists one or more application IDs together with one or more connection capabilities, the UE considers that the application IDs identify the applications requesting access to the connection capabilities.

If one or more DNNs are included in the TD of a URSP rule, the RSD of the URSP rule does not include any DNN.

The UE may be provisioned with URSP rules by the PCF of the home public land mobile network (HPLMN). When the UE is roaming, the PCF in the HPLMN may update the URSP rule in the UE. For URSP rules, the UE supports the provisioning from the PCF in the HPLMN. In addition, the UE may be also pre-configured with URSP rules (e.g., by the operator).

Only the URSP rules provisioned by the PCF is used by the UE, if both URSP rules provisioned by the PCF and pre-configured URSP rules are present. If no URSP rule is provisioned by the PCF, and the UE has pre-configured rules configured in both the universal subscriber identification module (USIM) and mobile equipment (ME), then only the pre-configured URSP rules configured in the USIM is used.

For every newly detected application the UE evaluates the URSP rules in the order of rule precedence and determines if the application is matching the TD of any URSP rule.

When a URSP rule is determined to be applicable for a given application, the UE selects an RSD within this URSP rule in the order of the RSD Precedence.

When a valid RSD is found, the UE determines if there is an existing PDU session that matches all components in the selected RSD. The UE compares the components of the selected RSD with the existing PDU Session(s) as follows.
For a component which only contains one value (e.g., SSC mode), the value of the PDU session has to be identical to the value specified in the RSD.
For a component which contains a list of values (e.g., Network Slice Selection), the value of the PDU session has to be identical to one of the values specified in the RSD.
When some component(s) is not present in the RSD, a PDU session is considered matching only if it was established without including the missing component(s) in the PDU session establishment request.
When the RSD includes a Time Window or a Location Criteria, the PDU session is considered matching only if the PDU session is associated with an RSD that has the same Time Window or a Location Criteria validity conditions.

When a matching PDU session exists, the UE associates the application to the existing PDU session. That is, the UE routes the traffic of the detected application on this PDU session.

If none of the existing PDU sessions matches, the UE tries to establish a new PDU session using the values specified by the selected RSD. If the PDU session establishment request is accepted, the UE associates the application to this new PDU session. If the PDU session establishment request is rejected, based on the rejection cause, the UE selects another combination of values in the currently selected RSD if any other value for the rejected component in the same RSD can be used. Otherwise, the UE selects the next RSD in the order of the RSD precedence, if any. If the UE fails to establish a PDU session with any of the RSDs, it tries other URSP rules in the order of Rule Precedence with matching TDs, except the URSP rule with the “match-all” TD, if any. The UE does not use the UE local configuration in this case.

The UE receives the updated URSP rules and (re-)evaluates their validities in a timely manner when certain conditions are met, for example:
the URSP is updated by the PCF;
the UE moves from EPC to SGC;
change of Allowed NSSAI or Configured NSSAI;
change of local access data network (LADN) DNN availability;
UE registers over 3GPP or non-3GPP access;
UE establishes connection to a wireless local area network (WLAN) access.

The RSD of a URSP rule is only considered valid if all of the following conditions are fulfilled:
If any S-NSSAI is present, the S-NSSAI is in the Allowed NSSAI for the non-roaming case and in the mapping of the Allowed NSSAI to HPLMN S-NSSAI(s) for the roaming case.
If any DNN is present and the DNN is an LADN DNN, the UE is in the area of availability of this LADN.
If Access Type preference is present and set to Multi-Access, the UE supports access traffic steering, switching, splitting (ATSSS).
If a Time Window is present and the time matches what is indicated in the Time Window.
If a Location Criteria is present and the UE location matches what is indicated in the Location Criteria.

If a matching URSP rule has no valid RSD, the UE tries other URSP rules in the order of Rule Precedence with matching TDs, except the URSP rule with “match-all” TD. The UE does not use the UE local configuration in this case.

When URSP rules are updated or their validity according to the conditions above change, the association of existing applications to PDU sessions may need to be re-evaluated. The UE may also re-evaluate the application to PDU Session association due to the following reasons:
periodic re-evaluation based on UE implementation;
an existing PDU session that is used for routing traffic of an application based on a URSP rule is released;
The expiration of Time Window in route selection validation criteria, i.e., the expiration of Time Window, or UE's location no longer matches the Location Criteria.

If the re-evaluation leads to a change of the application to PDU session association (e.g., the application is to be associated with another PDU session or a new PDU session needs to be established), the UE may enforce such changes in a timely manner based on implementation, e.g., immediately or when UE enters CM-IDLE state.

If the selected RSD contains a Non-Seamless Offload indication and the UE has established a connection to a WLAN access, the UE routes the traffic matching the TD of the URSP rule via the WLAN access outside of a PDU session.

Table 4 shows an example of a URSP rule.

TABLE 4

| Example URSP rules | | Comments |
|---|---|---|
| Rule Precedence = 1 | RSD Precedence = 1 | This URSP rule associates the traffic of |
| TD: Application | Network Slice | application “App1” with S-NSSAI-a, SSC |
| Identifiers = App1 | Selection: S-NSSAI-a | Mode 3, 3GPP access and the “internet” |
| | SSC Mode Selection: | DNN. |
| | SSC Mode 3 | It enforces the following routing policy: |
| | DNN Selection: | The traffic of App1 should be transferred on a |
| | internet | PDU session supporting S-NSSAI-a, SSC |
| | Access Type | Mode 3 and DNN = internet over 3GPP |
| | preference: 3GPP | access. If this PDU session is not established, |
| | access | the UE attempts to establish a PDU session |
| | | with S-NSSAI-a, SSC Mode 3 and the |
| | | “internet” DNN over 3GPP access. |
| Rule Precedence = 2 | RSD Precedence = 1 | This URSP rule associates the traffic of |
| TD: Application | Network Slice | application “App2” with S-NSSAI-a and |
| Identifiers = App2 | Selection: S-NSSAI-a | Non-3GPP access. |
| | Access Type | It enforces the following routing policy: |
| | preference: Non-3GPP | The traffic of application App2 should be |
| | access | transferred on a PDU session supporting S- |
| | | NSSAI-a using a Non-3GPP access. If this |
| | | PDU session is not established, the UE |
| | | attempts to establish a PDU session with S- |
| | | NSSAI-a over Access Type = non-3GPP |
| | | access. |
| | RSD Precedence = 2 | If the PDU session cannot be established, the |
| | Non-seamless Offload | traffic of App2 is directly offloaded to |
| | indication: Permitted | WLAN, if the UE is connected to a WLAN |
| | (WLAN SSID-a) | with SSID-a (based on the 2nd RSD) |
| Rule Precedence = 3 | RSD Precedence = 1 | This URSP rule associates the traffic of |
| TD: DNN = DNN_1 | Network Slice | applications that are configured to use |
| | Selection: S-NSSAI-a | DNN_1 with DNN_1, S-NSSAI-a over Non- |
| | Access Type | 3GPP access. |
| | preference: Non-3GPP | It enforces the following routing policy: |
| | access | The traffic of application(s) that are |
| | | configured to use DNN_1 should be |
| | | transferred on a PDU session supporting S- |
| | | NSSAI-a over Non-3GPP access. If this PDU |
| | | session is not established, the UE attempts to |
| | | establish the PDU session with S-NSSAI-a |
| | | over Non-3GPP access. |
| Rule Precedence = 4 | RSD Precedence = 1 | This URSP rule associates the application |
| TD: Application | Network Slice | “App1” and the connection capabilities |
| Identifiers = App1 | Selection: S-NSSAI-a | “internet” and “supl” with DNN_1, S- |
| Connection | DNN Selection: | NSSAI-a over Non-3GPP access. |
| Capabilities = “internet”, | DNN_1 | It enforces the following routing policy: |
| “supl” | Access Type | When the “App1” requests a network |
| | preference: Non-3GPP | connection with connection capability |
| | access | “internet” or “supl”, the UE establishes (if |
| | | not already established) a PDU session with |
| | | DNN_1 and S-NSSAI-a over Non-3GPP |
| | | access. After that, the UE routes the traffic |
| | | of “App1” over this PDU session. |
| Rule Precedence = 5 | RSD Precedence = 1 | This URSP rule associates the application |
| TD: Application | Network Slice | “App3” and the connection capability “ims” |
| Identifiers = App3 | Selection: S-NSSAI-c | with DNN_1, S-NSSAI-c and multi-access |
| Connection | DNN Selection: | connectivity. |
| Capabilities = “ims” | DNN_1 | It enforces the following routing policy: |
| | Access Type | When the “App3” requests a network |
| | preference: Multi- | connection with connection capability |
| | Access | “ims”, the UE establishes (if not already |
| | | established) a MA PDU Session with |
| | | DNN_1 and S-NSSAI-c. After that, the UE |
| | | routes the traffic of “App3” over this MA |
| | | PDU Session by using the received ATSSS |
| | | rules. |
| Rule Precedence = 6 | RSD Precedence = 1 | This URSP rule associates App 1 with |
| TD: Application | DNN Selection: | DNN_1, S-NSSAI-a with Multi Access |
| Identifiers = App1 | DNN_1 | connectivity. |
| | Network Slice | It enforces the following routing policy: |
| | Selection: S-NSSAI-a | The traffic of Application 1 should be |
| | Access Type | transferred on a PDU session supporting S- |
| | preference: Multi | NSSAI-a and DNN_1 according to the |
| | Access | received ATSSS rules. After that, the UE |
| | | routes the traffic of any other application |
| | | according to the ATSSS rule with match all |
| | | packet filters if available. |
| Rule Precedence = | RSD Precedence = 1 | This URSP rule associates all traffic not |
| lowest priority | Network Slice | matching any prior rule a PDU session with |
| Traffic Descriptor: * | Selection: S-NSSAI-b | S-NSSAI-b, SSC Mode 3 and the “internet” |
| | SSC Mode Selection: | DNN. |
| | SSC Mode 3 | It enforces the following routing policy: |
| | DNN Selection: | All traffic not matching any prior rule |
| | internet | should be transferred on a PDU session |
| | | supporting S-NSSAI-b, SSC Mode 3 and |
| | | DNN = internet with no access network |
| | | preference. |

As described above, in general, when the RSDs for the TD are the same, if there is no PDU session that meets the conditions of the RSD, establishment of a PDU session according to the conditions of the RSD is requested. If the PDU session that meets the conditions of the RSD was already established, the user data is transmitted using the PDU session. However, even though the RSD for the TD is the same, there may be a case where a separate PDU session is required without sharing the PDU session with other traffic. The followings are examples of cases in which a separate PDU session is required.

(1) In the 5G system, an additional authentication procedure may be performed for each PDU session. This additional authentication procedure may be called a secondary authentication and authorization procedure by the data network authentication authorization accounting (DN-AAA) server during PDU session establishment. Currently, there is no RSD defined for these secondary authentication and authorization procedures in the URSP. Therefore, a problem may arise when specific traffic requiring secondary authentication and authorization is defined with the same RSD as other traffic.

For example, a URSP may contain the following rules.
Rule 1: [TD: App=web browser], [RSD: DNN=internet]
Rule 2: [TD: App=banking], [RSD: DNN=internet]

In this case, “App=banking” (e.g., a banking application) may require a second authentication and authorization procedure. However, since both URSP Rule 1 and URSP Rule 2 have RSD set to DNN=internet, both traffic of the web browser application and traffic of the banking application are transmitted and/or routed using PDU sessions set to DNN=internet according to the RSD. That is, the traffic of the web browser application and the traffic of the banking application are not distinguished.

(2) Specific traffic may require user plane integrity protection (UPIP) rather than the control plane integrity protection. Since traffic with the same RSD uses the same PDU session, it may be difficult to distinguish the specific traffic even when UPIP is applied only to specific traffic.

(3) When testing the UE, the test may be performed using the same RSD, in which case traffic with the same RSD uses only the same PDU session. Therefore, there may be problems with testing multiple PDU sessions.

(4) In addition, there may be a case where a network operator wants to classify traffic for the same RSD.

However, for now, traffic with the same RSD should be transmitted and/or routed using only the same PDU session.

Hereinafter, when it is necessary to operate some traffic via a separate PDU session for the same RSD, a method for supporting the generation/establishment of a dedicated PDU session for a specific user traffic of the UE according to implementations of the present disclosure will be described.

Hereinafter, the UE and the terminal may be used interchangeably. Various implementations and/or embodiments of the present disclosure to be described below may be applied to various services, e.g., eMBB, V2X communication, public safety, IoT, etc. In addition, various implementations and/or embodiments of the present disclosure to be described below may be applied to various types of terminals, e.g., smartphones, vehicles, IoT terminals, robots, etc.

Various implementations and/or embodiments of the present disclosure to be described below may be performed individually, or two or more may be combined and performed in combination. In addition, combinations of operations/configurations/steps of one or more of the various implementations and/or embodiments herein described below may be performed.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

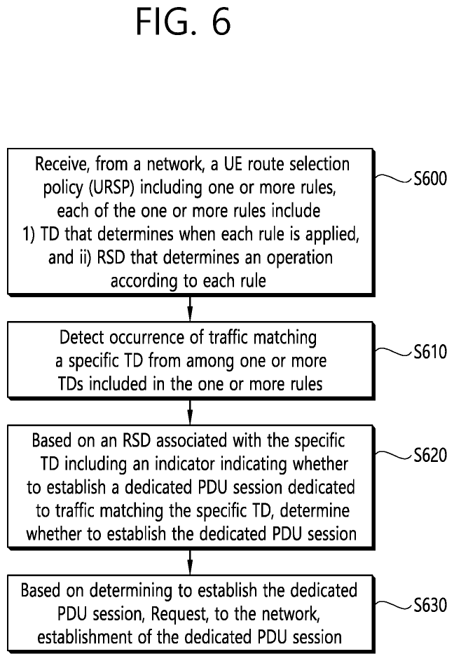

FIG. 6 shows an example of a method performed by a UE to which implementations of the present disclosure is applied.

In step S600, the method includes receiving a URSP comprising one or more rules from a network. Each of the one or more rules includes 1) a TD that determines when each rule is applied, and 2) an RSD that determines an operation according to each rule.

In step S610, the method includes detecting occurrence of traffic matching a specific TD among one or more TDs included in the one or more rules.

In step S620, the method includes determining whether to establish a dedicated PDU session, based on an RSD associated with the specific TD including an indicator indicating whether to establish the dedicated PDU session dedicated to traffic matching the specific TD. That is, the UE may determine whether to use the same PDU session or to establish the dedicated PDU session for the same RSD based on the indicator.

In step S630, the method includes requesting for establishing the dedicated PDU session to the network, based on determining the establishment of the dedicated PDU session.

In some implementations, the indicator may always indicate establishment of the dedicated PDU session for traffic matching the specific TD. That is, traffic matching the specific TD may always be transmitted and/or routed through the dedicated PDU session.

In some implementations, the indicator may indicate establishment of a PDU session for the traffic, based on the absence of a PDU session corresponding to the RSD including the indicator indicating non-establishment of the dedicated PDU session. That is, if a PDU session corresponding to the RSD already exists, traffic matching the specific TD may be transmitted and/or routed through the already existing PDU session. And, if a PDU session corresponding to the RSD does not exist, establishment of the PDU session may be requested for traffic matching the specific TD.

In some implementations, the indicator may consist of a 1-bit flag. For example, the presence of the 1-bit flag itself may indicate establishment of the dedicated PDU session. That is, if the 1-bit flag does not exist, it may implicitly indicate that establishment of the dedicated PDU session is not required. Alternatively, the 1-bit flag whose value is set to 1 may indicate establishment of the dedicated PDU session.

In some implementations, the indicator may consist of binary information indicating a specific PDU session. For example, establishment of the dedicated PDU session may be requested based on absence of the specific PDU session. That is, only when there is no specific PDU session indicated by the binary information, establishment of the PDU session may be requested. If the specific PDU session indicated by the binary information already exists, even if the specific PDU session does not match the RSD including the binary information, traffic matching the specific TD may be transmitted and/or routed through the specific PDU session.

In some implementations, the one or more rules may include one or more TDs according to protocol information. Accordingly, it is possible to classify the PDU session according to the protocol of the traffic. The protocol information may indicate hypertext transfer protocol (HTTP) or internet control message protocol (ICMP). The protocol information may be used together with or separately from the above-described indicator.

In some implementations, the UE may communicate with at least one of a mobile device, a network and/or an autonomous vehicle other than the UE.

Furthermore, the method in perspective of the UE described above in FIG. 6 may be performed by the first wireless device 100 shown in FIG. 2, the wireless device 100 shown in FIG. 3, and/or the UE 100 shown in FIG. 4.

More specifically, the UE comprises at least one transceiver, at least one processor, and at least one memory operably connectable to the at least one processor. The at least one memory stores instructions to cause the at least one processor to perform operations below.

The operations include includes receiving a URSP comprising one or more rules from a network. Each of the one or more rules includes 1) a TD that determines when each rule is applied, and 2) an RSD that determines an operation according to each rule.

The operations include detecting occurrence of traffic matching a specific TD among one or more TDs included in the one or more rules.

The operations include determining whether to establish a dedicated PDU session, based on an RSD associated with the specific TD including an indicator indicating whether to establish the dedicated PDU session dedicated to traffic matching the specific TD. That is, the UE may determine whether to use the same PDU session or to establish the dedicated PDU session for the same RSD based on the indicator.

The operations include requesting for establishing the dedicated PDU session to the network, based on determining the establishment of the dedicated PDU session.

In some implementations, the indicator may always indicate establishment of the dedicated PDU session for traffic matching the specific TD. That is, traffic matching the specific TD may always be transmitted and/or routed through the dedicated PDU session.

In some implementations, the indicator may indicate establishment of a PDU session for the traffic, based on the absence of a PDU session corresponding to the RSD including the indicator indicating non-establishment of the dedicated PDU session. That is, if a PDU session corresponding to the RSD already exists, traffic matching the specific TD may be transmitted and/or routed through the already existing PDU session. And, if a PDU session corresponding to the RSD does not exist, establishment of the PDU session may be requested for traffic matching the specific TD.

In some implementations, the indicator may consist of a 1-bit flag. For example, the presence of the 1-bit flag itself may indicate establishment of the dedicated PDU session. That is, if the 1-bit flag does not exist, it may implicitly indicate that establishment of the dedicated PDU session is not required. Alternatively, the 1-bit flag whose value is set to 1 may indicate establishment of the dedicated PDU session.

In some implementations, the indicator may consist of binary information indicating a specific PDU session. For example, establishment of the dedicated PDU session may be requested based on absence of the specific PDU session. That is, only when there is no specific PDU session indicated by the binary information, establishment of the PDU session may be requested. If the specific PDU session indicated by the binary information already exists, even if the specific PDU session does not match the RSD including the binary information, traffic matching the specific TD may be transmitted and/or routed through the specific PDU session.

In some implementations, the one or more rules may include one or more TDs according to protocol information. Accordingly, it is possible to classify the PDU session according to the protocol of the traffic. The protocol information may indicate hypertext transfer protocol (HTTP) or internet control message protocol (ICMP). The protocol information may be used together with or separately from the above-described indicator.

Furthermore, the method in perspective of the UE described above in FIG. 6 may be performed by control of the processor 102 included in the first wireless device 100 shown in FIG. 2, by control of the communication unit 110 and/or the control unit 120 included in the wireless device 100 shown in FIG. 3, and/or by control of the processor 102 included in the UE 100 shown in FIG. 4.

More specifically, an apparatus operating in a wireless communication system comprises at least one processor, and at least one memory operably connectable to the at least one processor. The at least one processor is adapted to perform operations comprising: obtaining a URSP including one or more rules, wherein each of the one or more rules include i) TD that determines when each rule is applied, and ii) RSD that determines an operation according to each rule, detecting occurrence of traffic matching a specific TD from among one or more TDs included in the one or more rules, based on an RSD associated with the specific TD including an indicator indicating whether to establish a dedicated PDU session dedicated to traffic matching the specific TD, determining whether to establish the dedicated PDU session, and based on determining to establish the dedicated PDU session, requesting, to the network, establishment of the dedicated PDU session.

Furthermore, the method in perspective of the UE described above in FIG. 6 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as synchronous dynamic random access memory (SDRAM), ROM, non-volatile random access memory (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory computer-readable medium (CRM) has stored thereon a plurality of instructions.

More specifically, CRM stores instructions to cause at least one processor to perform operations. The operations comprise: obtaining a URSP including one or more rules, wherein each of the one or more rules include i) TD that determines when each rule is applied, and ii) RSD that determines an operation according to each rule, detecting occurrence of traffic matching a specific TD from among one or more TDs included in the one or more rules, based on an RSD associated with the specific TD including an indicator indicating whether to establish a dedicated PDU session dedicated to traffic matching the specific TD, determining whether to establish the dedicated PDU session, and based on determining to establish the dedicated PDU session, requesting, to the network, establishment of the dedicated PDU session.

Hereinafter, various implementations of the present disclosure are described in detail.

1. First Implementation

According to the first implementation of the present disclosure, when the network configures the URSP for the UE, the network may newly configure the dedicated PDU session indicator. That is, when a specific rule in the URSP consists of a TD and an RSD and it is necessary to transmit and/or route traffic matching the corresponding TD on a separate PDU session regardless of the RSD associated with the corresponding TD, the network and/or operator may configure a dedicated PDU session indicator indicating whether to establish/use a separate or dedicated PDU session in the RSD included in the specific rule. The dedicated PDU session indicator may be simply referred to as an indicator hereinafter.

The indicator may indicate whether to establish/use a dedicated PDU session only for the specific rule that is distinguished/separated from the previously established PDU session when an operation according to the RSD of the corresponding rule is performed. Alternatively, the indicator may indicate to perform the operation according to the RSD of the specific rule, instead of whether to establish/use a dedicated PDU session only for the specific rule when performing the operation according to the RSD of the corresponding rule. That is, if a PDU session corresponding to the RSD has already been established, the corresponding PDU session may be used. And, if the PDU session corresponding to the RSD is not established, the dedicated PDU session may be used.

The operation of the UE receiving the rule including the indicator is specifically as follows. When user data traffic occurs, the UE finds a matching rule with the highest rule priority. If a matching rule is found, delivery of the user data traffic may be determined according to the RSD included in the matching rule. In this case, the UE may operate as follows according to the presence and/or value of the indicator.

(1) When the indicator is included in the RSD, and the indicator indicates that a dedicated PDU session is required for a specific rule including the RSD

When the indicator is a 1-bit flag, a flag set to “1” may indicate that a dedicated PDU session is required for a specific rule including the RSD. In this case, a flag set to “0” may indicate that a dedicated PDU session is not required for a specific rule including the RSD. Alternatively, the presence of the indicator included in the RSD may implicitly indicate that a dedicated PDU session is required for a specific rule including the RSD. If the indicator is not included in the RSD, it may indicate that a dedicated PDU session is not required for a specific rule including the RSD.

When user data traffic occurs in an upper layer of the UE and the specific rule is selected, the UE NAS layer determines whether there is a PDU session established by the specific rule. This procedure may be the same as adding a procedure for checking whether the PDU session is a PDU session established by the specific rule to the procedure for searching for a PDU session satisfying the RSD. For this, in the case of a PDU session in which the indicator is set or a PDU session for a rule that require a dedicated PDU session, information on the corresponding rule may be stored. The information may be stored by the UE internal implementation or may be indicated on an attribute of the corresponding PDU session.

When a PDU session established by the specific rule already exists, the UE NAS layer may transmit information about the corresponding PDU session to an upper layer so that user data traffic is transmitted and/or routed through the corresponding PDU session.

If a PDU session has not yet been established according to the specific rule, but a PDU session corresponding to the RSD included in the specific rule already exists, the UE does not select the corresponding PDU session according to the indicator. That is, the UE NAS layer may request establishment of a dedicated PDU session only for transmitting user data traffic corresponding to the specific rule while satisfying the RSD of the specific rule. When the establishment of a dedicated PDU session is requested, information binding to the specific rule may be added to the configuration of the dedicated PDU session. Alternatively, related information may be stored according to UE internal implementation.

When a PDU session has not yet been established by the specific rule and there is no PDU session corresponding to the RSD included in the specific rule, the UE NAS layer requests establishment of a dedicated PDU session only for transmitting user data traffic corresponding to the specific rule while satisfying the RSD of the specific rule.

(2) When the indicator is included in the RSD, and the indicator indicates that a dedicated PDU session is not required for a specific rule including the RSD

The UE does not need to consider the PDU session bound to the specific rule, but only considers whether a PDU session satisfying the RSD included in the specific rule exists. If a PDU session satisfying the RSD included in the specific rule exists, user data traffic may be transmitted and/or routed using the PDU session. And, if there is no PDU session satisfying the RSD included in the specific rule, establishment of a new PDU session satisfying the RSD may be requested.

Table 5 shows an example of the RSD according to the first implementation of the present disclosure.

TABLE 5

| | | | PCF permitted | |
|---|---|---|---|---|
| Information | | | to modify in | |
| name | Description | Category | URSP | Scope |
| Route Selection | Determines the order in which | Mandatory | Yes | UE |
| Descriptor | the RSDs are to be applied. | | | context |
| Precedence | | | | |
| Route selection | | Mandatory | | |
| components | | | | |
| SSC Mode | One single value of SSC mode. | Optional | Yes | UE |
| Selection | | | | context |
| Network Slice | Either a single value or a list of | Optional | Yes | UE |
| Selection | values of S-NSSAI(s). | | | context |
| DNN Selection | Either a single value or a list of | Optional | Yes | UE |
| | values of DNN(s). | | | context |
| PDU Session | One single value of PDU | Optional | Yes | UE |
| Type Selection | Session Type | | | context |
| Non-Seamless | Indicates if the traffic of the | Optional | Yes | UE |
| Offload | matching application is to be | (NOTE 4) | | context |
| indication | offloaded to non-3GPP access | | | |
| | outside of a PDU Session. | | | |
| Access Type | Indicates the preferred Access | Optional | Yes | UE |
| preference | Type (3GPP or non-3GPP or | | | context |
| | Multi-Access) when the UE | | | |
| | establishes a PDU Session for | | | |
| | the matching application. | | | |
| Dedicated | Indicates whether this rule | Optional | Yes | UE |
| Session | requires a dedicated/separate | | | context |
| preference/ | PDU session | | | |
| indication | | | | |
| Route Selection | | Optional | | |
| Validation | | | | |
| Criteria | | | | |
| Time Window | The time window when the | Optional | Yes | UE |
| | matching traffic is allowed/The | | | context |
| | RSD is not considered to be | | | |
| | valid if the current time is not in | | | |
| | the time window. | | | |
| Location | The UE location where the | Optional | Yes | UE |
| Criteria | matching traffic is allowed/The | | | context |
| | RSD rule is not considered to be | | | |
| | valid if the UE location does not | | | |
| | match the location criteria. | | | |

Referring to Table 5, the RSD includes “Dedicated Session preference/indication” information indicating whether a dedicated and/or separate PDU session is required.

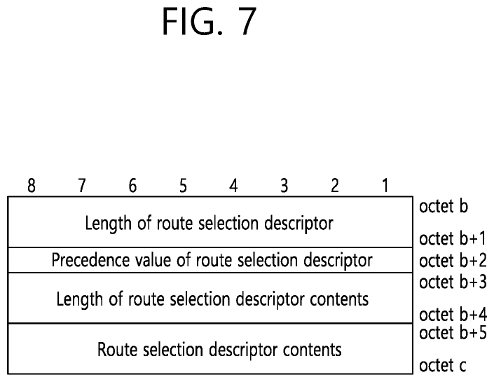

FIG. 7 shows an example of an RSD according to the first implementation of the present disclosure.

Referring to FIG. 7, the RSD includes an RSD contents field. The RSD contents field may have various sizes and includes at least one RSD component. Each RSD component is encoded as a sequence of one octet RSD component type identifier and an RSD component value field. The RSD component type identifier is transmitted first.

Table 6 shows an example of an RSD component type identifier.

TABLE 6

| Bit (bit8 - bit1) | RSD component |
|---|---|
| 0 0 0 0 0 0 0 1 | SSC mode type |
| 0 0 0 0 0 0 1 0 | S-NSSAI type |
| 0 0 0 0 0 1 0 0 | DNN type |
| 0 0 0 0 1 0 0 0 | PDU session type |
| 0 0 0 1 0 0 0 0 | Preferred connection type |
| 0 0 0 1 0 0 0 1 | Multi-access preference type |
| 1 0 0 0 0 0 0 0 | Time window type |
| 0 1 0 0 0 0 0 0 | Location criteria type |
| 0 0 1 0 0 0 0 0 | Non-seamless non-3GPP offload indication type |
| 0 0 1 0 0 0 0 1 | Dedicated (Separate) PDU session preference/indication |
| | type |

Referring to Table 6, RSD component type identifier with a value of “0 0 1 0 0 0 0 1” indicates a dedicated/separate PDU session preference/indication type. In this case, the RSD component does not include an RSD component value field. Also, the RSD component corresponding to the dedicated/separate PDU session preference/indication type should not appear more than once in the RSD.

An example of an operation according to the first implementation of the present disclosure is as follows.

It is assumed that a URSP including three rules is set as follows. Also, it is assumed that traffic from app1, app2, and app3 occurs in order.
Rule 1: [TD: app=app1]-[RSD: DNN=internet]
Rule 2: [TD: app=app2]-[RSD: DNN=internet, “dedicated PDU session indication”]
Rule 3: [TD: app=app3]-[RSD: DNN=internet, “dedicated PDU session indication”]

When traffic occurs in app1, rule 1 is matched, and PDU session #1 corresponding to DNN=internet is established. Thereafter, traffic generated from app1 uses PDU session #1. In this case, additional binding information is not required for PDU session #1, or information such as “generic” may be included. This may be divided into UE internal implementation.

When traffic occurs in app2, rule 2 is matched. Accordingly, if the previously established PDU session is checked, it can be seen that the PDU session #1 corresponding to DNN=internet has already been established and exists. However, since the RSD included in rule 2 includes a dedicated PDU session indicator, a new PDU session #2 is established instead of using the already existing PDU session #1. At this time, information that PDU session #2 matches rule 2 may be stored in the context within the UE or implemented inside the UE. In this case, a rule identifier such as “rule #2” or a TD such as “app=app2” may be stored.

When traffic occurs in app3, rule 3 is matched. Accordingly, if the established PDU session is checked first, it can be seen that PDU session #1 and PDU session #2 corresponding to DNN=internet have already been established and exist. However, since the RSD included in rule 3 includes a dedicated PDU session indicator, a new PDU session #3 is established instead of using the already existing PDU session #1 or PDU session #2. PDU session #2 cannot be used by rule 3 because binding information is different from rule 3. Information that PDU session #3 matches rule 3 may be stored in the context within the UE or implemented in the UE. In this case, a rule identifier such as “rule #3” or a TD such as “app=app3” may be stored.

2. Second Implementation

According to the second implementation of the present disclosure, binary information may be used instead of the dedicated PDU session indicator according to the above-described first implementation of the present disclosure. The binary information may indicate whether to use a dedicated PDU session for only the specific rule that is distinguished/separated from the previously established PDU session when an operation according to the RSD of the specific rule is performed. Alternatively, the binary information may indicate to perform the operation according to the RSD of the specific rule, instead of using a dedicated PDU session for only the specific rule when the operation according to the RSD of the specific rule is performed. That is, if a PDU session corresponding to the RSD has already been established, the corresponding PDU session may be used, and if the PDU session corresponding to the RSD is not established, the dedicated PDU session may be used.

The binary information may be composed of a specific value indicating that there is no need to create a dedicated PDU session and the remaining binary values. For example, when binary information has a size of 4 bits, a specific value that means that there is no need to create a dedicated PDU session may be set to “0”, and the remaining values 1-15 may be set the remaining binary values. The actual coding of the binary information may be different, and the extent of the binary information, i.e., the size of the binary information may also change.

The operation of the UE receiving the rule including the binary information is specifically as follows. When user data traffic occurs, the UE finds a matching rule with the highest rule priority. If a matching rule is found, delivery of the user data traffic may be determined according to the RSD included in the matching rule. In this case, the UE may operate as follows according to the existence and/or binary value of the binary information.

(1) When the binary information is included in the RSD, and the binary information indicates a binary value other than a value indicating that there is no need to create a dedicated PDU session

The UE may operate similarly to the case of receiving the dedicated PDU session indicator according to the first implementation of the present disclosure described above. That is, when binary information is included in the RSD, traffic satisfying the corresponding rule may be delivered using a PDU session dedicated to the corresponding rule among PDU sessions satisfying the corresponding RSD. However, an already established PDU session may be used according to the binary value.

When user data traffic occurs in an upper layer of the UE and the specific rule is selected, the UE NAS layer determines whether there is a PDU session established by the specific rule. This procedure may be the same as adding a procedure for checking whether the PDU session is a PDU session dedicated to the specific rule to the procedure for searching for a PDU session satisfying the RSD. To this end, the binary value indicated by the binary information may be compared with the binary value allocated to the searched PDU session. The information may be stored by the UE internal implementation or may be indicated on the setting of the corresponding PDU session.

If a PDU session having the same binary value as the binary value indicated by the binary information has already been established and exists, user data traffic may be transmitted by using the PDU session even if the corresponding PDU session is not a PDU session generated by the specific rule. When a PDU session established by the specific rule already exists, the UE NAS layer may transmit information about the corresponding PDU session to an upper higher layer so that user data traffic is transmitted and/or routed through the corresponding PDU session.

If a PDU session has not yet been established by the specific rule, or the binary value of a PDU session satisfying the RSD included in the specific rule does not match the binary value indicated by the binary information, the UE does not select the corresponding PDU session. That is, the UE NAS layer may request establishment of a PDU session matching the binary value indicated by the binary information while satisfying the RSD of the specific rule. If necessary, information that the binary value of the binary information is bound to the specific rule may be added to the configuration of the PDU session. Alternatively, related information may be stored according to UE internal implementation.

(2) When the binary information is included in the RSD, but the binary information is set to a value indicating that there is no need to create a dedicated PDU session, or the binary information is not included in the RSD

The UE does not need to consider the PDU session bound to the specific rule, but only considers whether a PDU session satisfying the RSD included in the specific rule exists. If a PDU session satisfying the RSD included in the specific rule exists, user data traffic may be transmitted and/or routed using the PDU session, and if there is no PDU session satisfying the RSD included in the specific rule, establishment of a new PDU session satisfying the RSD may be requested.

An example of an operation according to the second implementation of the present disclosure is as follows.

It is assumed that a URSP including three rules is set as follows. Also, it is assumed that traffic from app1, app2, and app3 occurs in order.
Rule 1: [TD: app=app1]-[RSD: DNN=internet, dedicated PDU session index=0]
Rule 2: [TD: app=app2]-[RSD: DNN=internet, dedicated PDU session index=1]
Rule 3: [TD: app=app3]-[RSD: DNN=internet, dedicated PDU session index=1]

When traffic occurs in app1, rule 1 is matched, and PDU session #1 corresponding to DNN=internet is established. Thereafter, traffic generated from app1 uses PDU session #1. At this time, since the value of the dedicated PDU session index for PDU session #1 is set to 0 in RSD, PDU session #1 may be set to a general PDU session without special binding, or binding information may be set to “index=0” or “generic”, etc.

When traffic occurs in app2, rule 2 is matched. Accordingly, if the previously established PDU session is checked, it can be seen that the PDU session #1 corresponding to DNN=internet has already been established and exists. However, the RSD included in Rule 2 includes a dedicated PDU session index set to “1”, which does not match PDU session #1 in which the value of the dedicated PDU session index is 0. Therefore, instead of using the already existing PDU session #1, a new PDU session #2 is established. At this time, information that PDU session #2 matches rule 2 may be stored in the context within the UE or implemented inside the UE.

When traffic occurs in app3, rule 3 is matched. Accordingly, if the established PDU session is checked first, it can be seen that PDU session #1 and PDU session #2 corresponding to DNN=internet have already been established and exist. Additionally, the RSD included in rule 3 includes a dedicated PDU session index set to “1”, which matches PDU session #2 in which the value of the dedicated PDU session index is 1. Accordingly, the traffic of App3 may be delivered using PDU session #2.

3. Third Implementation

Table 7 shows examples of currently defined TDs.

TABLE 7

| Application | |
|---|---|
| descriptors | It consists of OSId and OSAppId(s). |
| IP | Destination IP 3 tuple(s) (IP address or IPv6 network |
| descriptors | prefix, port number, protocol ID of the protocol above IP). |
| Domain | Destination FQDN(s) or a regular expression as a domain |
| descriptors | name matching criteria. |
| Non-IP | Descriptor(s) for destination information of non-IP traffic |
| descriptors | |
| DNN | This is matched against the DNN information provided by |
| | the application. |
| Connection | This is matched against the information provided by a UE |
| Capabilities | application when it requests a network connection with |
| | certain capabilities. |

According to the third implementation of the present disclosure, in order to classify traffic using a dedicated PDU session, the network and/or operator may additionally define protocol information in the URSP in the TD. Accordingly, in a situation where IP information cannot be known in advance, it is possible to separate/distinguish a PDU session according to a protocol. To this end, the upper layer may transmit protocol information to the URSP entity when checking the rules included in the URSP.

An example of an operation according to the third implementation of the present disclosure is as follows.

The following example has exemplarily described a case in which the third implementation of the present disclosure is used together with the binary information described in the above-described second implementation of the present disclosure. The third implementation of the present disclosure may be used together with the dedicated PDU session indicator described in the above-described first implementation of the present disclosure.
Rule 1: [TD: protocol=http]-[RSD: DNN=internet, dedicated PDU session index=0]
Rule 2: [TD: protocol=icmp]-[RSD: DNN=internet, dedicated PDU session index=1]

When HTTP traffic occurs, rule 1 is matched, and PDU session #1 corresponding to DNN=internet is established. After that, HTTP traffic uses PDU session #1. At this time, since the value of the dedicated PDU session index for PDU session #1 is set to 0 in RSD, PDU session #1 is set to a general PDU session without special binding, or binding information may be set to “index=0” or “generic”, etc.

Rule 2 is matched when ICMP traffic occurs. Accordingly, if the previously established PDU session is checked, it can be seen that the PDU session #1 corresponding to DNN=internet has already been established and exists. However, the RSD included in Rule 2 includes a dedicated PDU session index set to “1”, which does not match PDU session #1 in which the value of the dedicated PDU session index is 0. Therefore, instead of using the already existing PDU session #1, a new PDU session #2 is established. At this time, information that PDU session #2 matches rule 2 may be stored in the context within the UE or implemented inside the UE.

The present disclosure can have various advantageous effects.

For example, in a situation in which a PDU session is used according to the URSP in the 5G system, a separate and/or dedicated PDU session can be established/used for traffic having the same RSD.

For example, a PDU session can be separated for each traffic characteristic, and through this, user experience enhancement and security enhancement can be achieved.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) adapted to operate in a wireless communication system, the method comprising:
receiving, from a network, a UE route selection policy (URSP) including one or more rules,
wherein each of the one or more rules include i) a traffic descriptor (TD) that determines when each rule is applied, and ii) a route selection descriptor (RSD) that determines an operation according to each rule;
detecting occurrence of traffic matching a specific TD from among one or more TDs included in the one or more rules;
based on an RSD associated with the specific TD including an indicator indicating whether to establish a dedicated protocol data unit (PDU) session dedicated to traffic matching the specific TD, determining whether to establish the dedicated PDU session; and
based on determining to establish the dedicated PDU session, requesting, to the network, establishment of the dedicated PDU session.

2. The method of claim 1, wherein the indicator always indicates establishment of the dedicated PDU session for traffic matching the specific TD.

3. The method of claim 1, wherein the indicator indicates establishment of a PDU session for the traffic based on absence of a PDU session corresponding to the RSD including the indicator.

4. The method of claim 1, wherein the indicator consists of a 1-bit flag.

5. The method of claim 4, wherein presence of the 1-bit flag indicates establishment of the dedicated PDU session.

6. The method of claim 1, wherein the indicator consists of binary information indicating a specific PDU session.

7. The method of claim 6, wherein establishment of the dedicated PDU session is requested based on absence of the specific PDU session.

8. The method of claim 1, wherein the one or more rules include one or more TDs according to protocol information.

9. The method of claim 8, wherein the protocol information indicates a hypertext transfer protocol (HTTP) or an internet control message protocol (ICMP).

10. The method of claim 1, wherein the UE is in communication with at least one of a mobile device, a network, and/or autonomous vehicles other than the UE.

11. A user equipment (UE) adapted to operate in a wireless communication system, the UE comprising:
at least one transceiver;
at least one processor; and
at least one memory operably connectable to the at least one processor and storing instructions that, based on being executed by the at least one processor, perform operations comprising:
receiving, from a network, a UE route selection policy (URSP) including one or more rules,
wherein each of the one or more rules include i) a traffic descriptor (TD) that determines when each rule is applied, and ii) a route selection descriptor (RSD) that determines an operation according to each rule;
detecting occurrence of traffic matching a specific TD from among one or more TDs included in the one or more rules;
based on an RSD associated with the specific TD including an indicator indicating whether to establish a dedicated protocol data unit (PDU) session dedicated to traffic matching the specific TD, determining whether to establish the dedicated PDU session; and
based on determining to establish the dedicated PDU session, requesting, to the network, establishment of the dedicated PDU session.

12. The UE of claim 11, wherein the indicator consists of a 1-bit flag.

13. The UE of claim 11, wherein the indicator consists of binary information indicating a specific PDU session.

14. The UE of claim 11, wherein the one or more rules include one or more TDs according to protocol information.

15. A processing apparatus adapted to control a wireless device in a wireless communication system, the processing apparatus comprising:
at least one processor; and
at least one memory operably connectable to the at least one processor,
wherein the at least one processor is adapted to perform operations comprising:
obtaining a UE route selection policy (URSP) including one or more rules,
wherein each of the one or more rules include i) a traffic descriptor (TD) that determines when each rule is applied, and ii) a route selection descriptor (RSD) that determines an operation according to each rule;
detecting occurrence of traffic matching a specific TD from among one or more TDs included in the one or more rules;
based on an RSD associated with the specific TD including an indicator indicating whether to establish a dedicated protocol data unit (PDU) session dedicated to traffic matching the specific TD, determining whether to establish the dedicated PDU session; and
based on determining to establish the dedicated PDU session, requesting, to the network, establishment of the dedicated PDU session.

16. (canceled)
